(19) United States
(12) Patent Application Publication
(10) Pub. No.: US 2009/0319501 A1
(43) Pub. Date: Dec. 24, 2009

(54) TRANSLATION OF STREAMING QUERIES INTO SQL QUERIES

(75) Inventors: Jonathan David Goldstein, Kirkland, WA (US); Mingsheng Hong, Ithaca, NY (US)

Correspondence Address: Microsoft Corporation;Patent Group Docketing Dept., One Microsoft Way, Redmond, WA, 98052, US

(73) Assignee: Microsoft Corporation, Redmond, WA (US)

(21) Appl. No.: 12/144,698

(22) Filed: Jun. 24, 2008

(51) Int. Cl. G06F 7/06; G06F 17/30

(52) U.S. Cl. 707/4; 707/E17.014

(57) ABSTRACT

A query translation system and method for processing a streaming language query on existing or stored data. The streaming language query is applied against a data stream log by first translating the streaming language query into a database management system query (such as a SQL query) and then applying the translated streaming language query against the data stream log. Embodiments of the query translation system and method include a bitemporal converter that converts a bitemporal data stream log into a canonical history table format. Once in this format, embodiments of the query translation system and method translate a streaming language query into a SQL query. A categorization of each of the streaming operators that make up the streaming language query is performed to determine which translation technique to use. In general, one of three general translation techniques is used based on these categorizations of the streaming operators.

### BACKGROUND

A continuous data stream is a potentially unbounded sequence of tuples. A tuple is an ordered list of values or components. By way of example, the continuous data stream can be a stream of transactions or a measurement data stream of sensors. While this data stream can be processed live and in real time, it is also useful to process stream data stored in logs using a streaming query model. This type of processing is referred to as historic stream query processing.

An historic stream query is a stream query running on finite segments of archived streaming data. These queries are historic in the sense that some time-oriented subset of the log is used to produce the query result. There are important differences between the way that historic and continuous streaming queries are processed. For instance, historic streaming queries are one time queries, not continuous. Also, all the input is available prior to query execution. One strategy for processing such queries is to store the streaming data in stream logs and process the queries on demand.

There are at least two ways in which these event logs may be created. First, applications may generate such event logs explicitly for offline analysis. These types of logs are ubiquitous in many of today's large companies. Note that many businesses are already inundated with such logs, and are struggling to process them. Second, these event logs may be produced by a general purpose event and stream processing system, like complex event detection and response (CEDR). CEDR has the capability of logging event streams very quickly to files, approaching the maximum transfer rate of the hard drives.

Once the stream logs are created, current techniques process the logs in one of two general ways. One strategy is to feed the archived data (or stream log) into a streaming query engine (such as CEDR). In this case, the historical query is registered as a standing query. It is then removed when the archived data has been processed. CEDR query operators are used to process the stream log. A separate way to process the stream log is to use a database management system (DBMS), such as a structured query language (SQL) engine. It is well-understood that due to architectural differences, a DBMS is unsuitable for high-speed continuous query processing over live data streams. However, the characteristics of historic stream queries render a SQL engine a more suitable tool to process an historic stream query rather than a streaming query engine that is specially designed for processing live data streams.

Some DBMS techniques for processing stream logs have focused on integrating live stream processing with archived stream processing. One technique proposes to process temporal queries on top of a conventional DBMS, by building a layer which translates temporal queries into SQL queries. However, for efficiency, parts of the temporal queries are implemented by application code rather than SQL.

As compared to a streaming engine, a DBMS is more suitable for historic stream query processing. However, when using a DBMS, it is desirable to use a streaming query model to express the historic stream queries. It is not a good idea to express such queries directly in SQL for the following reasons. First, stream style queries typically have very cumbersome formulations in SQL. Second, the most straightforward formulations of such queries in SQL are typically compiled into highly sub-optimal plans by current SQL query optimizers. Thus, some combination of using a streaming approach for query formulation with a SQL engine for query execution is desirable for historic stream query processing of stream logs.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of the query translation system and method performs historic query steam processing on existing or stored data. A streaming language query is performed on a data stream log by translating the streaming language query into a database management system query (such as a SQL query). The translated streaming language query then is applied against the data stream log.

Embodiments of the query translation system and method perform stream query processing over logs rather than live data. Previous techniques assume that data streams are coming from sensors, computers, or from some other live data generator, and processing is done in real time. Embodiments of the system and method assume that events of the data stream are being stored. Subsequent to the storage of the data, rather than issuing a continuous query (or a query that never ends), instead a one-time query is issued using the temporal logic of a streaming query language rather than using the traditional logic that SQL uses.

Embodiments of the query translation system and method include a database operator translator that translates a streaming language query into a SQL query. This translation technique allows the processing of historic stream queries in a SQL engine against a data stream log. In some embodiments, a complex event detection and response (CEDR) operator is translated into an equivalent SQL query that can be evaluated efficiently. Prior to translation, the streaming language query is categorized to determine which translation technique to use.

A bitemporal converter is used to convert a bitemporal data stream log into a canonical history table format. This does not need to be performed if the data is already in this format. Once the data stream log is in a canonical history table format, embodiments of the query translation system and method translate a streaming language query into a SQL query. In general, one of three general translation techniques is used. First, a SQL-like operator translation technique may be used, if the streaming language query is classified as a SQL-like operator. Second, a snapshot-oriented operator translation technique may be used if the streaming language query is classified as a snapshot-oriented operator. Third, a Group&Apply operator translation technique may be used if the streaming language query is classified as a Group&Apply operator.

It should be noted that alternative embodiments are possible, and that steps and elements discussed herein may be changed, added, or eliminated, depending on the particular embodiment. These alternative embodiments include alternative steps and alternative elements that may be used, and structural changes that may be made, without departing from the scope of the invention.

### DRAWINGS DESCRIPTION

Referring now to the drawings in which like reference numbers represent corresponding parts throughout:

FIG. 1 is a block diagram illustrating a general overview of embodiments of the query translation system and method disclosed herein.

FIG. 2 is a block diagram illustrating details of embodiments of the query translation system and method shown in FIG. 1.

FIG. 3 is a block diagram illustrating details of embodiments of the database operator translator shown in FIGS. 1 and 2.

FIG. 4 is a flow diagram illustrating the operation of embodiments of the query translation system and method shown in FIGS. 1, 2, and 3.

FIG. 5 is a flow diagram illustrating the operation of embodiments of the bitemporal converter shown in FIG. 2.

FIG. 6 is a flow diagram illustrating the operation of embodiments of the database operator translator shown in FIGS. 2 and 3.

FIG. 7 is a flow diagram illustrating the operation of embodiments of the SQL-like operator translator shown in FIG. 3.

FIG. 8 is a flow diagram illustrating the operation of embodiments of the snapshot-oriented operator translator shown in FIG. 3.

FIG. 9 is a flow diagram illustrating the operation of embodiments of the Group&Apply operator translator shown in FIG. 3.

FIG. 10 illustrates an example of a suitable computing system environment in which embodiments of the query translation system and method shown in FIGS. 1-9 may be implemented.

### DETAILED DESCRIPTION

In the following description of embodiments of the query translation system and method reference is made to the accompanying drawings, which form a part thereof, and in which is shown by way of illustration a specific example whereby embodiments of the query translation system and method may be practiced. It is to be understood that other embodiments may be utilized and structural changes may be made without departing from the scope of the claimed subject matter.

### I. System Overview

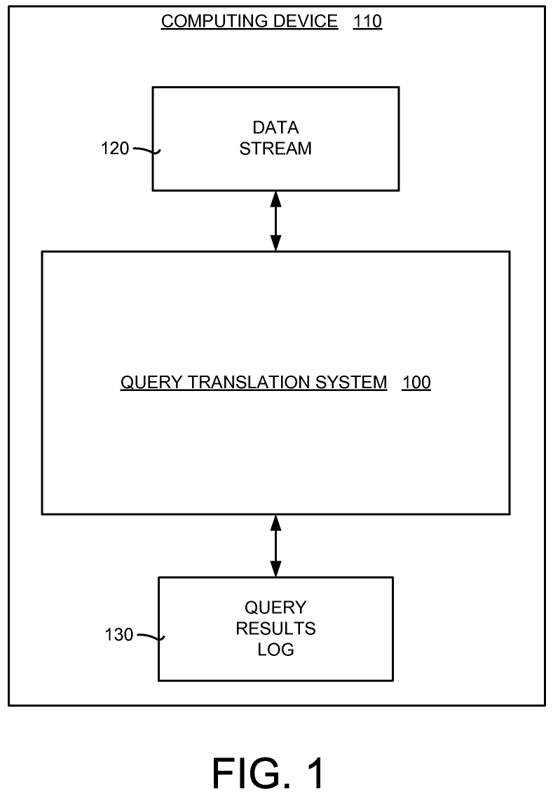

FIG. 1 is a block diagram illustrating a general overview of embodiments of the query translation system and method disclosed herein. It should be noted that the implementation shown in FIG. 1 is only one of many implementations that are possible. Referring to FIG. 1, a query translation system 100 is shown implemented on a computing device 110. It should be noted that the computing device 110 may include a single processor (such as a desktop or laptop computer) or several processors and computers connected to each other.

In general, the query translation system 100 inputs a data stream 120. This data stream is a continuous data stream that may, for example, be coming from sensors, computers, or from some other live data generator. Typically, processing on this data stream is done in real time. However, as discussed below, the query translation system 100 processes the data stream 120 to create data logs. These data logs then are processed by the query translation system 100. The output of the query translation system 100 is a query results log 130. The query results log 130 contains the results of the queries on the data stream 120. The queries are translated by the query translation system 100 from streaming operating queries into database management system (DBMS) queries (such as structured query language (SQL) queries). This translation process is discussed in detail below.

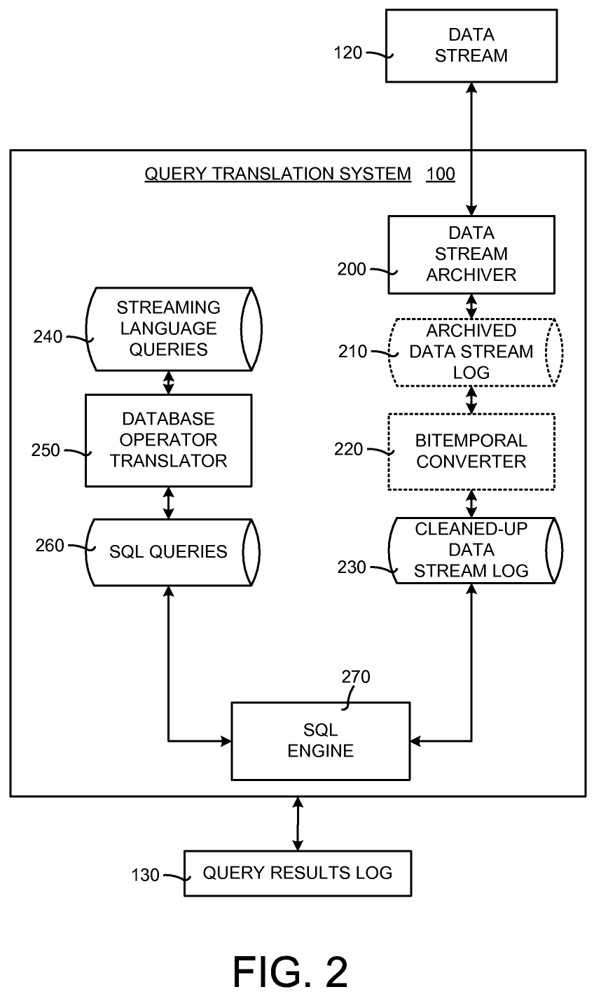

Embodiments of the query translation system 100 include a number of program modules. FIG. 2 is a block diagram illustrating details of embodiments of the query translation system 100 and method shown in FIG. 1. In general, FIG. 2 illustrates how the query translation system 100 goes from a streaming language query (such as a complex event detection and response (CEDR) query) to a DBMS query (such as a SQL query). Another way of saying this is that the CEDR query is mapped into a SQL query.

As noted above, the data stream 120 is input to the query translation system 100. The system 100 includes a data stream archiver 200, which archives the data stream 120 to create an archived data stream log 210. The archived data stream log is fed into a bitemporal converter 220, which “cleans up” the archived data stream log 210. The result is a cleaned up data stream log 230. As explained below, by “cleaned up” it is meant that the data is in a canonical history table format. The dashed lines for the archived data stream log 210 and the bitemporal converter 220 in FIG. 2 mean that those components may or may not run need to be run for each query. These components may need to be run only once for a particular data set, and then will not have to be run for subsequent queries. By way of example, multiple queries might share the same bitemporal converter such that it only needs to be run once.

The cleaned-up data stream log 230 having data in a canonical history table format is queried using a streaming language query (such as a CEDR query). In particular, streaming language queries 240 are used to query the cleaned-up data stream log 230. A database operator translator 250 translates and converts these streaming language queries 240 into DBMS queries (such as SQL query results 260). These SQL queries 260 then are applied to the cleaned-up data stream log 230 using a SQL engine 270. The output of applying the SQL queries 260 to the cleaned-up data stream log 230 is the query results log 130.

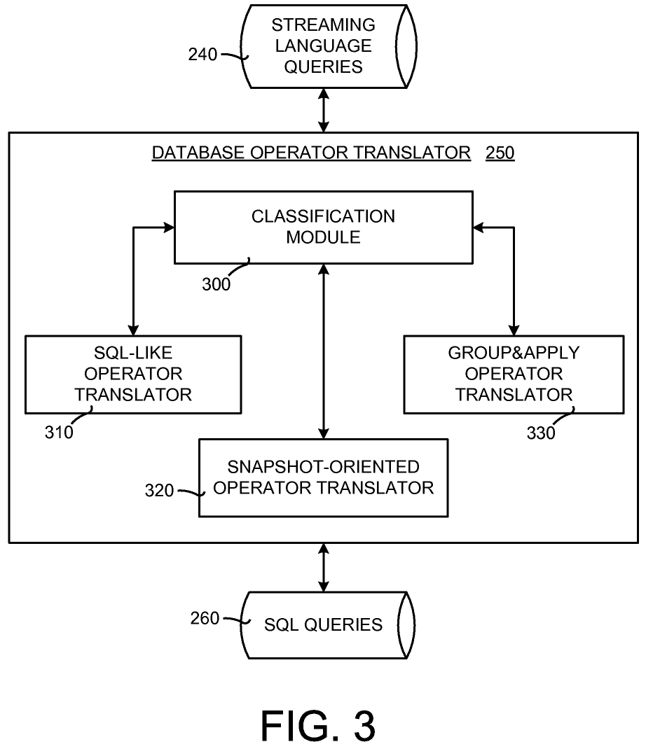

Embodiments of the query translation system 100 include the database operator translator 250. FIG. 3 is a block diagram illustrating details of embodiments of the database operator translator 250 shown in FIGS. 1 and 2. In general, the database operator translator 250 inputs the streaming language queries 240 and outputs the translated streaming language queries as the SQL queries 260. More specifically, the database operator translator 250 includes a classification module 300 that decomposes each of the streaming language queries 240 into their respective streaming operators and then classifies each of the streaming operators. As explained in detail below, how a streaming operator is classified has impact on which type of translation technique is used.

The database operator translator 250 includes a SQL-like operator translator 310, which is used to translate streaming language queries classified as SQL-like operators. A snapshot-oriented operator translator 320 is used to translate streaming language queries classified as snapshot-oriented operators. Moreover, a Group&Apply operator translator 330 is used to translate streaming language queries classified as Group&Apply operators.

### II. Operational Overview

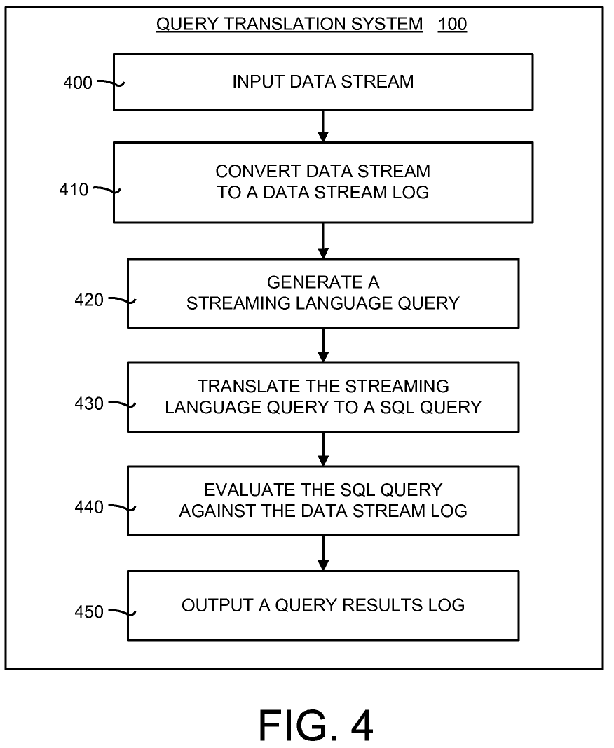

FIG. 4 is a flow diagram illustrating the operation of embodiments of the query translation system 100 and method shown in FIGS. 1, 2, and 3. The method begins by inputting a data stream (box 400). The data stream is converted into a data stream log (box 410). This data stream log is in a canonical history table format. The details of ensuring that the data stream log is in a canonical history table format are detailed below.

The method then generates a streaming language query (box 420). This may be done automatically, or by having a user generate the query. Once a streaming language query is generated, the query is translated into a SQL query (box 430). As explained in detail below, this is done by decomposing the streaming language query into its constituent streaming operators and then translating the streaming operators to obtain the SQL query. The SQL query then is evaluated against the data stream log (box 440). The output of the method is a query results log (box 450).

### III. Operational Details

The operational details of embodiments of the query translation system 100 and method now will be discussed. These embodiments include embodiments of the program modules shown in FIGS. 2 and 3. The operational details of each of these programs modules now will be discussed.

### III.A. Bitemporal Converter

For live stream processing, the streaming language queries read and produce bitemporal streams. On the other hand, for historic stream query processing, the goal is to obtain stream query results on archived streams which have already been converted into their canonical forms. Therefore, in some cases the bitemporal converter may only need to be invoked on the initial conversion. Alternatively, the conversion from a bitemporal format to a canonical history table format may be performed offline as a preprocessing step.

The bitemporal stream allows speculation. The bitemporal converter removes this speculation from the stream. The bitemporal converter converts the data stream having speculative answers into a final or concrete answer. This can be thought of as a cleaning process. III.A.1. Temporal Stream Models

In this section, unitemporal and bitemporal stream models are reviewed. Many existing stream models assume that for each event there is a timestamp belonging to an application domain. Since the event contains only one notion of time (application time), this refer to this stream model as unitemporal. The bitemporal stream model supports application time, as well as a second, independent notion of time. This second notion of time is called local processing server time (or CEDR time). Besides the temporal attributes, in both stream models, each event contains a fixed set of attribute values. This means that both models conform to a relational schema. These attribute values are referred to as the payload component of the event.

In traditional unitemporal stream models, it is well-understood that each stream is a time-varying relation. In other words, each event is an insert into the underlying relation of the stream. A unitemporal stream is append-only with respect to the application time. This means that an event with application time t indicates that it is in the underlying relation starting at time t. A valid interval [Vₛ, Vₑ) of an event is defined to be the application time during which this event remains in the underlying relation. The schema of a unitemporal stream then can be represented by (Vₛ, Vₑ; P). Here, Vₛ and Vₑ are respectively referred to as valid start time and valid end time, and P denotes the relational schema of the payload component. In traditional unitemporal stream models, the attribute Vₑ is redundant, since each event has a Vₑ value of infinity.

In contrast, a bitemporal stream is append-only with respect to the CEDR time. In other words, events are appended to the stream with strictly increasing CEDR time values. A CEDR bitemporal stream S encodes a relation called a virtual relation R, whose content will be defined based on the events in S (described in detail below). R is time-varying with respect to CEDR time. For each CEDR time T. R_{T} denotes the content of R associated with stream S up to T. Each R_{T} itself is time-varying with respect to the application time. That is, each R_{T} can be viewed as a unitemporal stream. In unitemporal stream models, “event” and “tuple” are often interchangeable terms. To disambiguate the terminology in the bitemporal stream model, “event” is used to refer to a tuple in a bitemporal stream, and “tuple” is used to refer to a tuple in its virtual relation.

There are three types of events in the bitemporal stream model. The first type of event is an insert, which inserts a tuple into the virtual relation associated with the stream. As in the unitemporal stream model, each insert event has a valid interval [Vₛ, Vₑ), indicating the application time interval during which the corresponding tuple is in the virtual relation. The second type of event is a retraction, which can shorten the valid interval of a tuple in the virtual relation, by reducing the value of its valid end time from the original Vₑ value to the V_{newe} value carried by this retraction event. Note that the valid interval of a tuple can be shortened multiple times by a sequence of retraction events in the bitemporal stream (with increasing CEDR time values). In order to associate a retraction event with a tuple in the virtual relation, it is required that the retraction event carry the valid interval, as well as the payload content of the tuple it corresponds to in the virtual relation. Retraction events can be either generated by data sources or by the CEDR stream engine. The third type of event is called a current time increment (CTI). A CTI event is similar to a heartbeat or punctuation in the stream literature. A CTI event with application time t and CEDR time T indicates that the content of the virtual relation up to (application time) t should no longer be changed by any future events in the input stream (in other words, any event whose CEDR time is greater than T).

The schema of a bitemporal stream has the following structure (Type, Vₛ, Vₑ, V_{newe}; P). Type indicates whether the stream tuple is an insert, retraction, or CTI. Vₛ and Vₑ together specify the valid interval of the tuple in the virtual relation. V_{newe} is only specified for a retraction event to indicate the new valid end time of its corresponding tuple. Note that the information of CEDR time is not explicitly represented in the schema. Rather, it is given by the ordering of tuples in the bitemporal stream. P denotes the set of attributes in the payload component of the schema.

The bitemporal stream model generalizes the unitemporal stream model in two aspects. First, tuples can take Vₑ values other than infinity. This is useful in many application scenarios, such as, for example, when modeling the expiration time of coupons. It is also essential for modeling windows. Also, the ability to shorten valid intervals through retractions enables the stream engine to use fine grained speculative execution as a method of dealing with out of order event delivery. An event e is out-of-order, if there is another event e′ with Vₛ value greater than that of e, but CEDR time less than that of e.

### III.A.2. Bitemporal Converter

The bitemporal converter 220 removes the speculative aspect of the archived data stream log 210. Specifically, the data stream 120 (which is a bitemporal stream S) can be converted into its canonical history table (which is a unitemporal stream) by incorporating all the retraction events in S into content changes of the virtual relation. The canonical history table therefore stores the eventual content of the virtual relation. Note that while a bitemporal stream is a sequence of events where ordering is important, its canonical history table is a standard relation, where tuple ordering is immaterial.

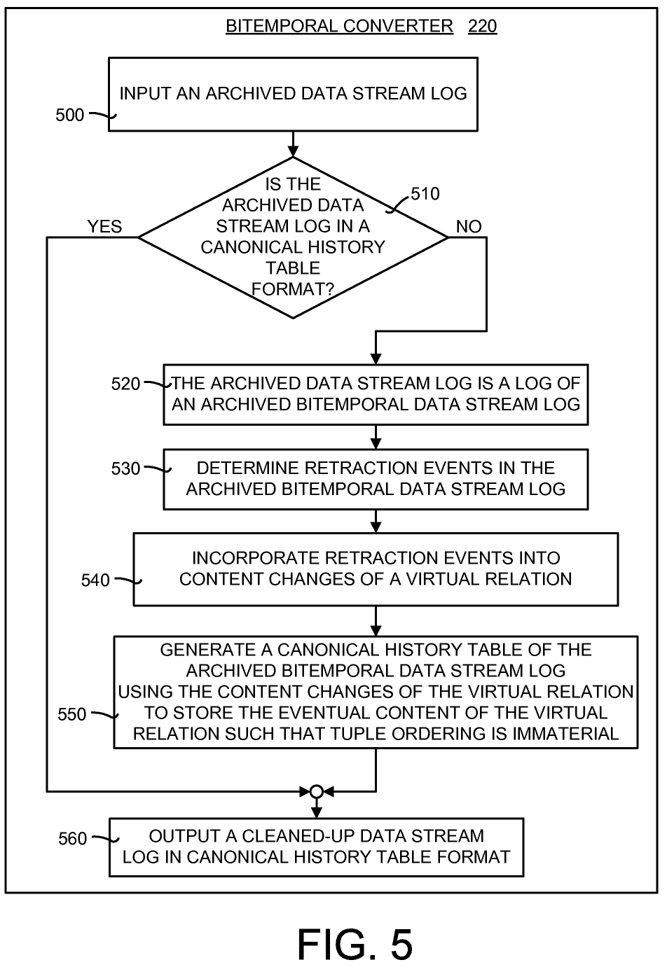

FIG. 5 is a flow diagram illustrating the operation of embodiments of the bitemporal converter 220 shown in FIG. 2. The operation begins by inputting an archived data stream log (box 500). Next, a determination is made as to whether the archived data stream log is in a canonical history table format (box 510). If not, then the archived data stream log is a log of an archived bitemporal data stream log and needs to be converted using the bitemporal converter 220 (box 520).

Let the function that converts a bitemporal stream to its canonical history table be,

S[.],

referred to as a bitemporal converter function. As a shorthand, given a sequence of bitemporal streams denoted as,

\vec{S},

the corresponding sequence of canonical history tables is denoted as,

S[\vec{S}].

In some embodiments, the bitemporal converter 220 is a DBMS stored procedure. First, the bitemporal converter 220 determines retraction events in the bitemporal data stream (box 530). This means that a SQL query is executed to retrieve the input events from a SQL table storing the archived stream. The SQL table has been populated by existing DBMS data importing mechanisms (such as bulk loads).

The event retrieval by the SQL query is in an order which minimizes the size of the state that the bitemporal converter 220 needs in order to produce the correct canonical history table. This order is described as follows. The retraction events are incorporated into content changes of a virtual relation (box 540). This is done as follows. First, all events are sorted by their Vₛ time in an ascending order. For those events with the same Vₛ time, insert events are followed by retraction events, which are followed by CTI events. Furthermore, among retraction events corresponding to the same tuple in the virtual relation, they are sorted by their Vₑ value in a descending order. In some embodiments, this ordering is achieved using the SQL clause ORDER BY Vₛ, Type, Vₛ DESC.

The bitemporal converter 220 then generates a canonical history table of the bitemporal data stream by using the content changes of the virtual relation to store the eventual content of the virtual relation (box 550). This is done such that tuple ordering is immaterial. The stored procedure opens a cursor to read the result of the above query row by row, and performs the following processing. For each insert event, the event is stored in an associative array based on the content of the valid interval and payload. For each retraction event, the corresponding entry is found in the associative array, and the Vₑ value of that entry is modified to be the V_{newe} value of the retraction event. For each CTI event, the entries of the associative array are flushed into the output canonical history table. It should be noted that by using this cursor-based design and the memory flushing mechanism via CTI events, the bitemporal converter 220 does not have to load the entire archived stream into memory. Finally, the bitemporal converter 220 outputs a “cleaned-up” data stream log that is in a canonical history table format (box 560).

In the case where the input bitemporal stream has no retraction events, instead of performing the above logic, the bitemporal converter 220 simply selects the insert events, and projects out the attributes Type and V_{newe}. This “fast path” significantly speeds up the bitemporal converter 220.

### III.B. Database Operator Translator

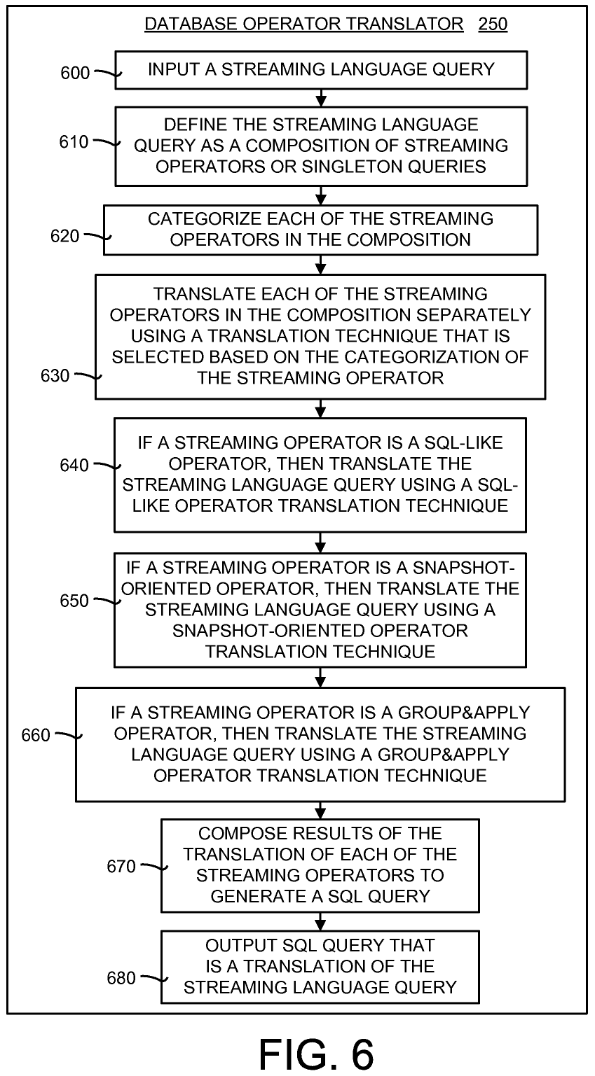

In this section, the details of the database operator translator 240 will be discussed. FIG. 6 is a flow diagram illustrating the operation of embodiments of the database operator translator 250 shown in FIGS. 2 and 3. The translator 250 first inputs a streaming language query (box 600). Next, the streaming language query is defined as a composition of streaming operators, or singleton queries (box 610). Each streaming operator in the composition then is categorized (box 620). Each of the streaming operators in the composition then is translated separately using a translation technique that is selected based on the categorization of a particular streaming operator (box 630). In other words, the translation technique used to translate each streaming operator depends on how the streaming operator is categorized. The translation techniques are described in detail below.

If the streaming language query is categorized as a SQL-like operator, then it is translated using a SQL-like operator translation technique (box 640). If the streaming language query is categorized as a snapshot-oriented operator, then it is translated using a snapshot-oriented operator translation technique (box 650). If the streaming language query is categorized as a Group&Apply operator, then it is translated using a Group&Apply operator translation technique (box 660). Each of these translation techniques for the streaming operators is discussed in detail below. The results of the translation of each of the streaming operators are composed to bring the translation results together and generate a SQL query (box 670). The output of the database operator translator 250 is SQL query that is a translation of the streaming language query, or, more correctly, a translation into SQL operators of each of the streaming operators that make up the streaming language query (box 680).

To describe the translation techniques used by embodiments of the database operator translator 240, the theoretical foundation for CEDR query translation first will be discussed. Next, a formal discussion of the notion of correctness and an inductive translation scheme (a key element in reducing the complexity of the translation problem from the query to the operator level) is set forth. Finally, the CEDR operators are classified into three categories, and each category will be described.

### III.B.1. Correctness of Query Translation

When a historic stream query is processed in a SQL engine, what does it mean for the SQL engine to produce correct result? The semantics of logical CEDR queries are defined on canonical history tables. Given a CEDR query Q and a sequence of canonical history tables,

\vec{S},

as its input, its output canonical history table according to the query semantics is denoted as,

Q(\vec{S}).

To encode a canonical history table into a relation, embodiments of the database operator translator use the relational schema (Vs, Ve, P). Given this correspondence between canonical history tables and SQL tables, in the following text no distinction is made between these two terms.

Let the translation function from CEDR queries to SQL queries be,

T[.].

Here, a correctness criteria is defined for,

T[.].

Given a CEDR query Q, it is said that the translation function is correct with respect to Q, if for all sequences of canonical history tables,

\vec{S}

as input of,

Q, Q(\vec{S})=(T[Q])(\vec{S}).

The translation function is correct if it is correct with respect to each of the CEDR queries.

### III.B.2. Inductive Translation Framework

The database operator translator 250 uses an inductive translation scheme. The inductive translation scheme replaces each streaming language query with a series of SQL Create View statements. Each Create View statement will refer to other Views below it, or to the canonical input log.

A SQL query is a way of writing a program that processes data. It refers to data that is stored in a database, and those are the input table, and it produces output, which is also in the form of a table. Fundamentally, the SQL query is a program that inputs several tables and outputs a single table.

The inductive translation scheme translates each of the streaming language operators in the streaming language query tree where each of those operators represent programs that take as input a stream and then they output a stream. The translator 250 takes each of the streaming language operators and replaces them with a SQL statement. Then, the translator 250 wraps that SQL statement in something called a View. A View is an object that does not actually perform computations until asked, but is given arguments and SQL query to be run.

The inductive translation scheme takes each of the streaming language operators and compiles them into a SQL statement. Instead of taking an input stream the scheme uses an input table, which is a log of all the events that were in this stream. Instead of having a plurality of input streams (like a streaming language operator would have), instead there are a plurality of input tables, which are logs over those streams. Moreover, instead of producing an output stream an output table is produced. The results of these queries are wired together using these Create View statements.

Since a CEDR query Q is composed of CEDR operators, embodiments of the database operator translator define a translation function,

T[.],

by using a structural induction on Q. Given that each CEDR operator is either unary or binary, the induction has two cases to consider as follows.

First, if

Q=ν(Q₁)⁵,

where, ν is a unary CEDR operator, then

T[Q]=(T[ν])(T[Q₁]).

Note that given two queries Q1 and Q2, the terminology Q1(Q2) is used to denote their composition, where the output of Q2 is the input of Q1. On the other hand, the notion Q(S) means evaluating Q on stream S.

Second, if

Q=ν(Q₁, Q₂),

where ν is a binary CEDR operator, then

T[Q]=(T[ν])(T[Q₁]T[Q₂]).

Given the translation function

T[.],

the correctness of the translation function is proven as follows. Since there is an infinite number of CEDR queries, the correctness of

T[.],

cannot be checked with respect to each CEDR query individually. The following theorem shows that in order to check the correctness of

T[.],

on all queries, it suffices to check the correctness of

T[.],

on those queries involving one single CEDR operator, referred to as singleton queries. Since there are only a handful of CEDR operators, this result makes it feasible to prove the correctness of

[.].

THEOREM 1: If T[.] is correct with respect to all singleton queries, then T[.] is correct.

Theorem 1 allows the following approach to be taken to CEDR query translation. First, each CEDR operator is translated into a SQL query. Next, these queries are composed to obtain a SQL query equivalent to the input CEDR query. To conveniently express the composition of these SQL queries, embodiments of the database operator translator use the SQL CREATE VIEW statement. By way of example, in order to compose two SQL queries Q1 with Q2, a view V is defined whose body is Q2. Next, the input to Q1 is specified as V (in the FROM clause) in the corresponding view definition for Q1.

### III.B.3. CEDR Queries and Operators

Complex event detection and response (CEDR) queries are streaming language queries that are compositions of a number of operators. First, there are the stream versions of selection, projection, union, join, aggregation, TopK, and AntiSemiJoin, whose counterparts exist in SQL. Next, the Group&Apply operator generalizes SQL Groupby. Finally, the AlterLifeTime operator is unique to the CEDR algebra. It can manipulate the temporal attributes Vₛ and Vₑ subject to certain constraints, and is the operator used for windowing in CEDR. In comparison, no other CEDR operators can read or modify the temporal attributes. The formal semantics of these CEDR operators will be described in detail below.

Some embodiments of the query translation system 100 and method represent SQL queries in Microsoft® Transact-SQL (or T-SQL), a popular dialect of SQL. Some embodiments strive to use the language features in the SQL standard whenever possible. However, for efficiency, sometimes embodiments of the query translation system 100 and method make use of special performance enhancement features provided by SQL Server.

### III.B.4. CEDR Operator Categorization

The CEDR operators described above in the “Queries” section are divided into three categories according to the techniques that are used in translating them. The first category includes the easily translated SQL-like operators. These operators include selection, projection, AlterLifeTime, union and join. The second category includes Aggregate, AntiSemiJoin and TopK. They are referred to as snapshot-oriented operators, since their semantics are all defined based on the snapshots of the virtual relation modeled by the input stream. The third category consists of one operator Group&Apply. It is a generalization of the SQL Groupby operator. The semantics and translation of each category of CEDR operator is described below.

### IlI.B.5. SQL-Like Operator Translation

In this section the translation techniques for SQL-like operators are presented. First, the Selection operator and Project operators are discussed. Then, the translation of the AlterLifeTime and Union operators is discussed.

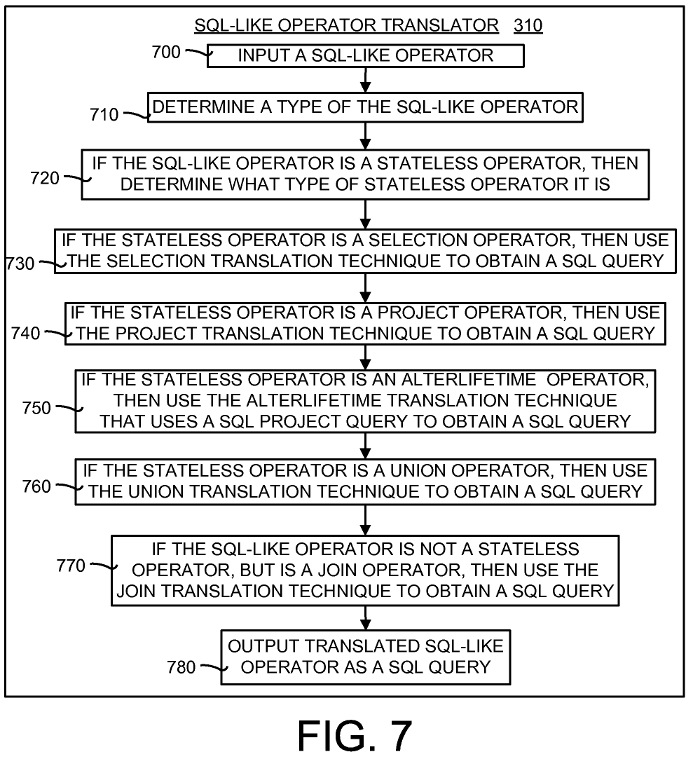

FIG. 7 is a flow diagram illustrating the operation of embodiments of the SQL-like operator translator shown 310 in FIG. 3. The translator 310 begins by inputting a SQL-like operator (box 700). Next, a determination is made as to the type of SQL-like operator (box 710). Specifically, the translation technique depends on the type. The different translation techniques for the SQL-like operators will now be discussed.

III.B.5.a. Stateless Operator Translation

If the SQL-like operator is a stateless operator, then the type of stateless operator is determined (box 720). If the stateless operator is a Selection operator, then a Selection translation technique is used to obtain a SQL query (box 730). The first operator described is the Select operator, denoted as σ. The Select operator selects all events in the canonical history table for which the filtering predicate holds. Its translation into SQL is then a simple select over the input, with the select predicate appearing in the WHERE clause. Each of the stateless operators essentially is translated like the Select operator. For example, the translation for the Select operator written as a SQL statement is “CREATE VIEW V0 AS SELECT, Vs, Ve tid, FROM S”.

If the stateless operator is a Project operator, then a Project translation technique is used to obtain a SQL query (box 740). Project operators become simple SQL project queries where the Project expressions of the SQL queries match exactly the Project expressions of the Project operators. In SQL, the Project operator takes data for a particular event and allows the calculation of a new row from an old row. Contents of the row can change, but the valid time of the row must remain the same. By way of example, the translation for the Project operator written as a SQL statement is “CREATE VIEW V0 AS SELECT Vs, Ve, (the function it is passed) FROM S”.

If the stateless operator is an AlterLifeTime operator, then an AlterLifeTime translation technique is used to obtain a SQL query (box 750). The AlterLifeTime operator, which recomputes the lifetime of a tuple, can be used for windowing (such as moving averages, etc.). It is basically a temporal Project operator. The AlterLifeTime operator can alter window size and align beginning of window to certain boundaries.

The AlterLifeTime operator becomes a SQL project query that recomputes the Vₛ and Vₑ values according to the given AlterLifeTime functions. The AlterLifeTime operator takes 2 functions (a window size and align valid start). By way of example, the AlterLifeTime operator can be translated to the SQL query: “CREATE VIEW V_{0 AS SELECT V}ₛ, Vₛ+2 AS Vₑ, tid FROM S”, where S is the input stream and tid is the thread identification. This query can be denoted as Q₀.

If the stateless operator is a Union operator, then a Union translation technique is used to obtain a SQL query (box 760). The Union operator is a streaming language query that translates directly into a SQL Union query.

III.B.5.b. CEDR Join Operator Translation

If the SQL-like operator is not a stateless operator, but is a Join operator, then a Join translation technique is used to obtain a SQL query (box 770). The CEDR join operator is similar to the join operator in temporal databases and can be defined formally as follows:

S₁ [symbol] _{θ}S₂={(Vₛ, Vₑ; e₁, P, e₂, P)|e₁εS₁, e₂εS₂, (e₁, e₂) [symbol] θ, Vₛ<Vₑ, where Vₛ=max(e₁, Vₛ,e₂, Vₛ), Vₑ=min(e₁, Vₑ, e₂, Vₑ)}.

Essentially, this operator extends the relational join operator with a “hard-coded” temporal join condition that ensures that 2 tuples can join only if their valid intervals overlap. In the translated SQL query, the temporal join condition can be expressed as additional predicates in the WHERE clause as follows: SELECT max(S1.Vₛ, S2.Vₛ) AS Vₛ, min(S1. Vₑ, S2.Vₑ) AS Vₑ, P FROM S1, S2, WHERE θ^{SQL} AND S1.Vₛ<S2.Vₑ AND S2.Vₛ<S1.Vₑ.

Here min and max are user defined functions with the obvious semantics. P refers to the payload attributes in the input streams S1 and S2, and θ^{SQL} denotes the join predicate θ in SQL syntax. The output of the SQL-like operator translator 310 is a translated SQL-like operator that is a SQL query (box 780).

### III.B.6. Snapshot-Oriented Operator Translation

In this section the translation techniques for snapshot-oriented operators is presented. These translation techniques cover a wide range of translations. The only CEDR operators that cannot be translated in using these snapshot-oriented operator translation techniques are the SQL-like operators and the Group&Apply operator. First, an in-depth treatment on the aggregation operator and its semantics is given. Then, the translation approaches for the snapshot-oriented operators are detailed. The TopK and AntiSemi-Join operators can be handled in a similar way. A translation of the TopK operator then is described.

From time (1) to time (2) there is a table of things that have changed. Another name for a table is a relation. The table from time (2) to time (3) has the same schema as from time (1) to time (2), but is a different relation because the values are different. This stream is describing a set of changing relations. Streams describe how relations change over time. These operators interpret the stream as a snapshot operator. Most of the operators can be translated as snapshot-oriented operators.

III.B.6.a. Semantics

The following supporting constructs are used to define the semantics of the snapshot-oriented operators. These semantics describe how an actual snapshot is determined, or where each unique snapshot begins and ends. An array C describes where the intervals are that contain unique snapshots. The set F holds the contents of each snapshot at a particular time.

These snapshot-oriented operators interpret the stream as a set of changing snapshot. Then they apply SQL logic to each of these snapshots in order to figure out the correct output. Below is given a generic technique to translate these snapshot-oriented operators.

First, given a stream S, let C be an array of end points of the valid intervals of the tuples in S, sorted in an ascending order. Formally,

C=sort({e.Vₛ|eεS}∪{e.Vₑ|eεS}),

where sort takes an input set of values (eliminating duplicates), and produces an output array of these values in
an ascending order. Let |C| denote the cardinality of C, and its elements are accessed with notation C_{[l]}.

Let Fₜ be the set of tuples from S whose valid intervals cover the interval defined by C[t] and C[t+1]. Formally,

F₁={eεS|e.Vₛ≦C[t],e,Vₑ≧C[t+1]}.

The semantics of the aggregation operator, denoted as α, is as follows:

$${α}_{X} ( S ) = {⋃}_{1 \leq t < \vert C \vert - 1} ( C [ t ] , C [ t + 1 ] ; {a}_{t} )$$

$$where {a}_{t} = {⊗}_{e ∈ {F}_{t .}} e \cdot X .$$

Here \textcircled{x} is a mathematical aggregation operator corresponding to the type of α. For example, if α is SUM, then \textcircled{x} is Σ. Intuitively, for each set of tuples defined by Fₜ, α aggregates over them on the aggregation attribute X, and produces an output tuple, whose valid interval is defined by C[t] and C[t+1].

III.B.6.b. Translation Overview

The translation of snapshot-oriented operators can be divided into three steps, where the first two steps are independent of the different snapshot-oriented operators, and the last step is operator specific. The first two steps are described in detail in this section, while the third step in described in detail in the next section.

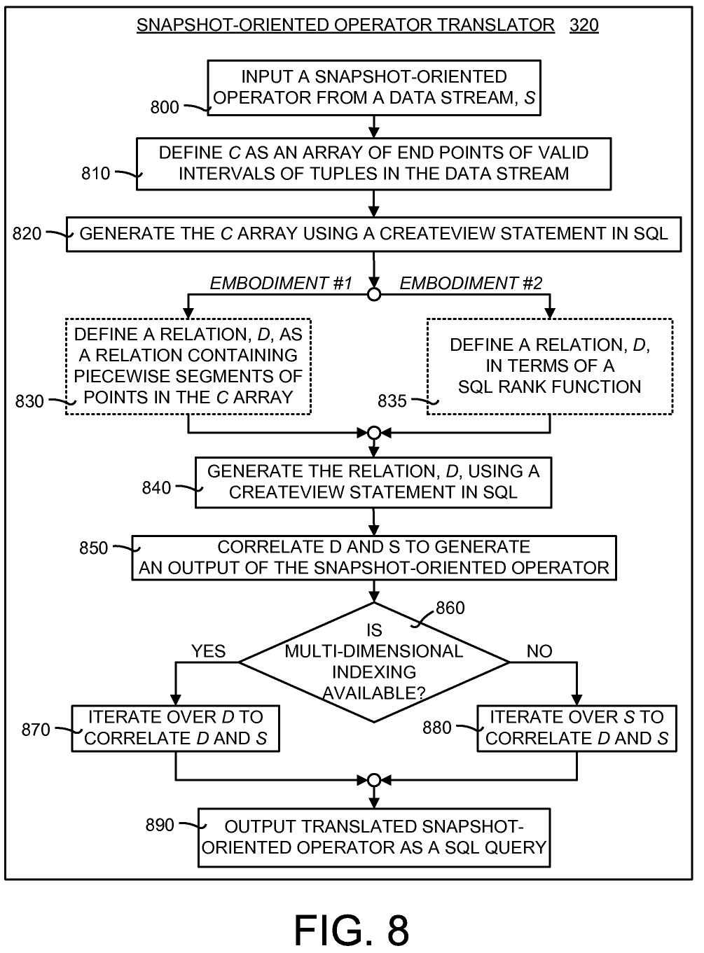

FIG. 8 is a flow diagram illustrating the operation of embodiments of the snapshot-oriented operator translator 320 shown in FIG. 3. The method begins by inputting a snapshot-oriented operator from a data stream, S (box 800). Next, C is defined as an array of end points of valid intervals of tuples in the data stream, S (box 810). The next step is to generate the C array, as defined above, using a CREATE VIEW statement in SQL (box 820). This is achieved by the following SQL statement:

CREATE VIEW V_{C} AS
SELECT DISTINCT V_{S} AS Point
FROM S
UNION
SELECT DISTINCT Vₑ AS Point
FROM S

The term V_{C} identifies the transitions, while D creates intervals (or turns V_{C} into intervals). These intervals should describe the start and end times of unique snapshots over the array C.

In a first embodiment, a relation, D, then is defined that contains piecewise segments of points in the C array (box 830). Next, the relation D is generated by defining using the following SQL statement (box 840):

CREATE VIEW D AS
SELECT C1.Point AS V_{S}, C2.Point AS Vₑ
FROM V_{C} AS C1, V_{C} AS C2
WHERE C2.Point > C1.Point AND C2.Point <= ALL
(SELECT C3.Point
FROM V_{C} AS C3
WHERE C3.Point > C1.Point)

Intuitively, this query selects each pair of consecutive points in the input. However, the above query formulation for creating D from C is not efficient. Thus, in a second embodiment, the relation D is defined in terms of a SQL Rank function (box 835). In other words, a more efficient query formulation is to use the rank() function native in Transact SQL (T-SQL) by Microsoft®. Next, the relation D is generated using the following SQL statement (box 840):

CREATE VIEW RankedC AS
SELECT Point, rank( ) OVER (ORDER BY Point) AS Rank
FROM V_{C}
CREATE VIEW D AS
SELECT C1.Point AS start, C2.Point AS end
FROM RankedC AS C1, RankedC AS C2
WHERE C2.Rank = C1.Rank+1

In the following text, the size of S is assumed to be n. The above formulation reduces the time complexity of the query evaluation from O(n^{2) to O(nlogn).}

III.B.6.c. Correlating D and S in Aggregate

Referring again to FIG. 8, the third step is to correlate D and S to generate the output of the snapshot-oriented operator, or the Aggregate operator (box 850). The essential logic is as follows. For each tuple d in D, retrieve all tuples in S that intersect it in the valid interval. Next, aggregate all these tuples on their aggregate attribute X, and then produce an output tuple containing the aggregate result in the payload, with valid interval set to that of d. Alternatively, the above logic can be expressed by iterating over all tuples in S instead of D. This is selected by determining whether multi-dimensional indexing is available (box 860). If so, then the next step is to iterate over D to correlate D and S, as discussed below (box 870). If not, then the next step is to iterate over S to correlate D and S, as also discussed below (box 880). Once the correlation of D and S is performed, then the output is the translated snapshot-oriented operator as a SQL operator (box 890).

It is first shown how to express in SQL the above logic, which requires iteration over one of the two input relations. A straightforward way to achieve this is to use a loop, an imperative programming feature. However, it is desirable to leverage the expressive power of SQL as much as possible. Below are presented two possible solutions for correlating D and S, along with an analysis of each of their complexity.

D stores intervals, and S is the data stream log. In general, each of the tuples is aggregated. This generates on one output tuple for each snapshot. The essence of the idea is that there are events and intervals, and somehow these events and intervals are turned into snapshots. The SQL queries then are executed over the snapshots.

III.B.6.c.i. Iterating Over D

For a given tuple in D, it is possible to aggregate over all relevant tuples in S using the CROSS APPLY operator. This allows iteration over a given relation, and on each tuple performs an arbitrary SQL computation. The resulting SQL formulation is as follows:

```
  CREATE VIEW AggResult AS
  SELECT D.V_{S} AS V_{S}, D.Vₑ AS Vₑ, AggValue
  FROM D
  CROSS APPLY (
  SELECT AGGTYPE(X) AS AggValue
  FROM S
  WHERE S. V_{S} <= D.V_{S} AND S.Vₑ >= D.Vₑ
) AS ApplyResult
```

AGGTYPE in the above SQL query corresponds to the type of the aggregate function. For example, if the aggregate function is SUM, AGGTYPE is the SQL SUM operator.

In the above query, an efficient evaluation of the join from D to S using the predicate S.Vₛ<=D.Vₛ AND S.Vₑ>=D.Vₑ requires that S be simultaneously indexed on both S.Vₛ and S.Vₑ, requiring a multi-dimensional index. The complexity analysis of the query now is set forth, both with and without a multi-dimensional index under the following assumption. Namely, For each tuple d in D, the number of tuples to retrieve in S, denoted as m_{d}, has a constant upper bound. This is a reasonable assumption since m_{d} only depends on the number of overlapping valid intervals of the tuples in S, not the size of S.

With a multi-dimensional index, the analysis is as follows. For each tuple d in D, with a multi-dimensional index on S the tuples in S can be retrieved that will join with d in time O(logn). Also, the size of D is O(n). Therefore, the time cost of the SQL query above is O(nlogn).

With no multi-dimensional index, the analysis is as follows. In this case, the above SQL query cannot, in general, be efficiently evaluated. For each tuple d in D, the number of tuples in S that have to be scanned, even with the help of a one-dimensional index, say, on S.Vₛ, is close to n. Therefore, the time cost of the SQL query above becomes O(n^{2).}

Unfortunately, many commercial SQL engines currently do not support multi-dimensional indexing. However, without this multi-dimensional indexing the above SQL query is likely not to scale well with the size of input streams. Therefore, a large class of stream queries is identified and exploited where a simplification of the join condition may be inferred by examining other operators in the plan. This results in efficient evaluation of the aggregate with the support of a one-dimensional index on the Vₛ attribute of S.

For many stream queries, there is an established relationship between S.Vₛ and S.Vₑ. For example, a timebased sliding window aggregation is expressed in CEDR, such as by composing Aggregate with AlterLifeTime, the output stream of the AlterLifeTime operator has the property that the Vₑ value of each tuple is equal to Vₛ+w, where w is the window size. This output stream of AlterLifeTime is the input stream of Aggregate, which is denoted as S.

In this case, the join predicate in the above SQL query can be rewritten to S.Vₛ <=D.Vₛ AND S.Vₛ>=D.Vₑ−w. Now, as Vₛ is the only attribute in S being accessed by the join predicate, the modified SQL query can be efficiently executed by probing a one-dimensional index on S.Vₛ.

III.B.6.c.ii. Iterating Over S

The previous approach for iterating over D gives rise to a SQL query using the CROSS APPLY operator. However, as the analysis shows, without the support of a good multi-dimensional index, even though the resulting SQL query can be efficiently evaluated in special cases, in general the time cost is quadratic in the input size. This significantly limits the scalability of this solution.

An alternate embodiment uses a general-purpose solution with the support of only a one-dimensional index. This embodiment uses two CREATE VIEW statements. In general, each event is divided into pieces so that each of the pieces corresponds to a snapshot in which that event participates. This is called “shredded input”. Next, the results are aggregated together.

This embodiment is based on iterating over tuples in S as follows. First, for each tuple s in S, retrieve the “relevant” tuples in D. In other words, retrieve those D tuples whose valid intervals overlap with the valid interval of s. Then enough bookkeeping is performed to maintain the running aggregate values for each interval defined by D. After processing all tuples in S, the running aggregate values associated with the intervals in D can be output.

It was noted above that for each D tuple, retrieving the set of “relevant” tuples in S requires a multi-dimensional join between D:Vₛ, D:Vₑ, S:Vₛ and S:Vₑ. Intuitively, it would seem that for each S tuple, retrieving the set of “relevant” tuples in D would require a similar multi-dimensional join, expressed by the join predicate θ:=S:Vₛ<D:Vₑ AND S:Vₑ>D:Vₛ. It should be noted that another equivalent predicate formulation is S:V_{s≦}D:Vₛ AND S:Vₑ>D:Vₑ. These two formulations are equivalent because of the special properties of the intervals in D. Namely, that they are consecutive and non-overlapping, and that there is no other end point in S between any two consecutive end points in D. It is possible, however, to simplify the predicate in all situations so that is does not depend on D:Vₑ. This allows the efficient use of a single dimensional index on D:Vₛ.

A key observation is that there is a special relationship between tuples in D and S. In particular, for each interval d in D and each tuple s in S, either d is disjoint with the valid interval of s, or d is contained within the valid interval of s. Therefore, the join predicate θ is equivalent to S:Vₛ<=D:Vₛ AND S:Vₑ>D:Vₛ.

Another challenge with this embodiment is that SQL cannot express the above procedural logic for maintaining running aggregates for each tuple in S. To cope with this difficulty in SQL, D is first joined with S to “shred” the tuples in S according to the intervals in D. This is performed as follows:

```
CREATE VIEW ShreddedInput AS
  SELECT D.V_{S} AS V_{S}, D.Vₑ AS Vₑ, P
  FROM S, D
  WHERE S.V_{S} <= D.V_{S} AND S.Vₑ > D.V_{S}
```

Next, these shredded tuples can be aggregated according to their valid interval values. This is expressible with SQL Groupby operator as follows:

```
CREATE VIEW AggResult AS
  SELECT V_{S}, Vₑ, AGGTYPE(X)
  FROM ShreddedInput
  GROUP BY V_{S}, Vₑ
```

One issue with this translation is that the size of the intermediate result containing the shredded tuples from S may become large when there is, on average, a large number of overlapping tuples at each time point in S. Recall from the discussion above that for each D tuple d, the upper bound of the number of S tuples whose valid intervals overlap with d is denoted as m_{d}. Then the size of the intermediate relation could be O(m_{d}n). However, when m_{d} is a small value, this approach benefits from its universal ease of evaluation among SQL engines because no multi-dimensional index is necessary.

The above CREATE VIEW statements are written in the context of Aggregation. If some other snapshot-oriented operator other than Aggregation is used then the terms inside CROSS APPLY (where it says SELECT Aggtype) and the terms inside the AggResult would change. This change would be to whatever operation is the SQL correspondence to whatever operation is in the streaming language.

III.B.6.d. Translation of the TopK Operator

The semantics of the TopK operator, which is denoted as τ, are as follows:

$${τ}_{k , X} ( S ) = {⋃}_{1 \leq t < \vert C \vert - 1} {⋃}_{r ∈ {A}_{t}} ( C [ t ] , C [ t + 1 ] ; r )$$

$$where {A}_{t} = {topK}_{k , X} ( {F}_{t} ) .$$

Here C and Fₜ are defined above, and,

topK_{k,X}

is the SQL TopK operator with ties.

As an instance of the snapshot-oriented operators, τ can be translated in three steps. The first two steps are the same as the general first two steps for the translation of snapshot-oriented operators, which were presented above.

The third step can be implemented by iterating over D or iterating over S, similar to the translation of the Aggregate operator. The solution for iterating over D is as follows:

```
SELECT D.V_{S} AS V_{S}, D.Vₑ AS Vₑ, S.P, Rank
FROM D
CROSS APPLY (
  SELECT TOP(k) WITH TIES *,
          rank( ) OVER (ORDER BY X DESC) AS Rank
  FROM S
  WHERE S.V_{S} <= D.V_{S} AND S.Vₑ >= D.Vₑ
    ORDER BY X DESC
) AS ApplyResult
```

The S.P in the SELECT clause denotes the payload. It means whatever columns are in S. In other words, it is a shorthand way of writing all the columns in S. Thus, the S.P, Rank term is all the columns in S plus a Rank.

Intuitively, for each tuple in D, it retrieves all tuples from S whose valid intervals contain that of the D-tuple, picks the top k tuples among them with ties (with the TOP clause), and assigns ranks to them (with the rank() function).

### III.B.7. Group&Apply Operator Translation

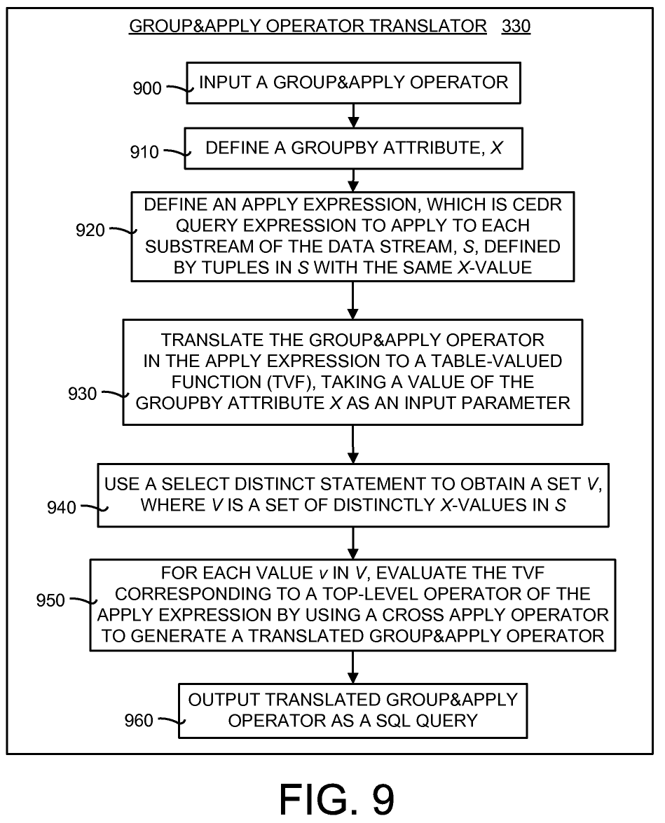

In this section the translation techniques for the CEDR Group&Apply operator are presented. FIG. 9 is a flow diagram illustrating the operation of embodiments of the Group&Apply operator translator 330 shown in FIG. 3. The method begins by inputting a Group&Apply operator (box 900). Next, a Groupby attribute X is defined (box 910). The CEDR Group&Apply operator takes one input stream S, and two input parameters: the Groupby attribute X, and the apply expression ε, which is a CEDR query expression to apply to each substream of S defined by tuples in S with the same X-value. More generally, the Group&Apply operator can group the tuples in the input stream by an arbitrary function over multiple attributes, instead of one single attribute X. For simplicity only one Groupby attribute is considered.

Referring again to FIG. 9, the translator 330 defines an apply expression (box 920). The apply expression is a CEDR query expression to apply to each substream of the data stream, S, defined by tuples in S with the same X-value. The output stream is a union of the output streams produced by the apply expressions evaluated on each substream. The apply expression ε must have the substream, denoted as @S, as one of its input streams. For each invocation of ε on a particular substream, @S is replaced by that substream.

The formal semantics of Group&Apply, denoted as γ, are as follows:

$${γ}_{X , ɛ} ( S ) = {⋃}_{v ∈ V} ɛ [ @ S ↦ {σ}_{X = v} ( S ) ] .$$

V is the set of distinct X-values in S, and

ε[@S→σx=ν(S)]

represents the CEDR expression ε being modified to replace its input stream @S with the substream defined by expression

σx=ν(S).

The CEDR Group&Apply operator is more powerful than the SQL Groupby operator. This is because the apply expression can be an arbitrarily complex CEDR query expression as opposed to a single aggregation function, as in the case of SQL. As a result, the number of output tuples for each input group is not limited to 1. This makes it unsuitable to translate the CEDR Group&Apply operator directly into a SQL query using the SQL Groupby operator.

There are two major issues in translating Group&Apply. First, each CEDR operator in the apply expression should be translated into a SQL query that is parameterized on the input relation. This way, each time the apply expression is evaluated on a different substream, the SQL query corresponding to the apply expression does not have to be regenerated and recompiled. Parameterized SQL queries can be expressed by Table-Valued Functions (TVF) in T-SQL. Therefore, when translating the CEDR operators in the apply expression, instead of using CREATE VIEW statements to achieve compositionality (as was described above), a CREATE FUNCTION statement is used.

Second, for each substream defined by the Groupby attribute X, the apply expression needs to be evaluated, and then the results produced by the apply expression need be union to produce the output stream of Group&Apply. A straightforward way to achieve this is again to use an imperative loop. However, thanks to the CROSS APPLY operator in T-SQL, the same effect can be achieved.

Referring again to FIG. 9, a translation is performed of the Group&Apply operator in the apply expression to a table-valued function (TVF), taking a value of the Groupby attribute X as the input parameter (box 930). Next, a SELECT DISTINCT statement is used to obtain a set V as defined in the semantics of Group&Apply (box 940). In particular, V is a set of distinct X-values in S. Finally, for each value v in V, a CROSS APPLY operator is used to evaluate the TVF corresponding to the top-level operator of the apply expression, instantiated with v (box 950). The output of the Group&Apply operator translator 330 is a translated Group&Apply operator as a SQL query (box 960).

### IV. Exemplary Operating Environment

Embodiments of the query translation system 100 and method are designed to operate in a computing environment. The following discussion is intended to provide a brief, general description of a suitable computing environment in which embodiments of the query translation system 100 and method may be implemented.

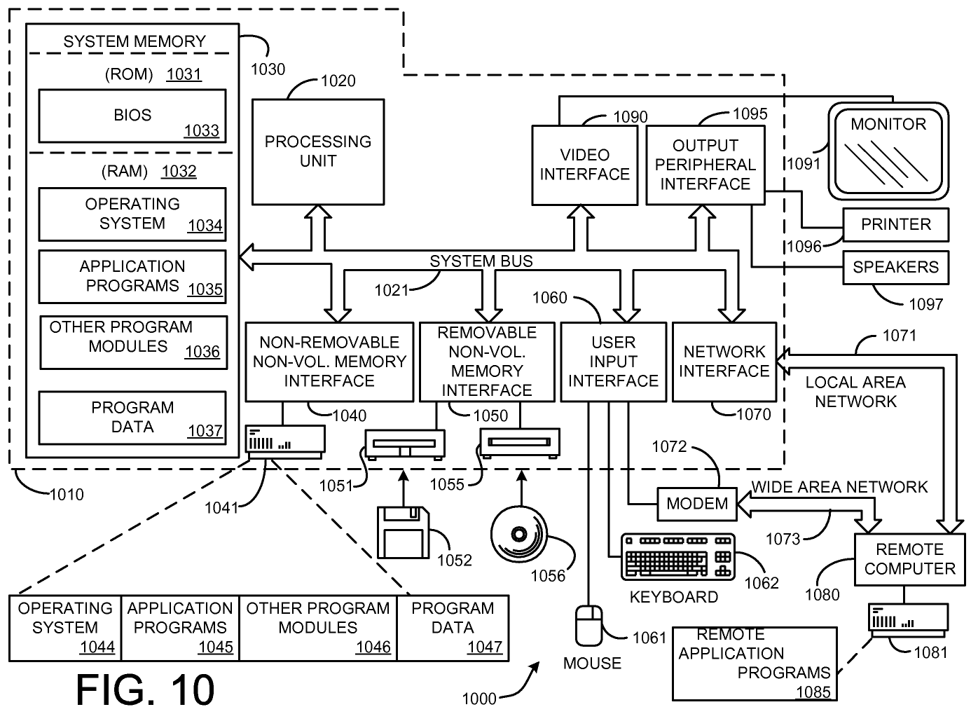

FIG. 10 illustrates an example of a suitable computing system environment in which embodiments of the query translation system 100 and method shown in FIGS. 1-9 may be implemented. The computing system environment 1000 is only one example of a suitable computing environment and is not intended to suggest any limitation as to the scope of use or functionality of the invention. Neither should the computing environment 1000 be interpreted as having any dependency or requirement relating to any one or combination of components illustrated in the exemplary operating environment.

Embodiments of the query translation system 100 and method are operational with numerous other general purpose or special purpose computing system environments or configurations. Examples of well known computing systems, environments, and/or configurations that may be suitable for use with embodiments of the query translation system 100 and method include, but are not limited to, personal computers, server computers, hand-held (including smartphones), laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

Embodiments of the query translation system 100 and method may be described in the general context of computer-executable instructions, such as program modules, being executed by a computer. Generally, program modules include routines, programs, objects, components, data structures, etc., that perform particular tasks or implement particular abstract data types. Embodiments of the query translation system 100 and method may also be practiced in distributed computing environments where tasks are performed by remote processing devices that are linked through a communications network. In a distributed computing environment, program modules may be located in both local and remote computer storage media including memory storage devices. With reference to FIG. 10, an exemplary system for embodiments of the query translation system 100 and method includes a general-purpose computing device in the form of a computer 1010.

Components of the computer 1010 may include, but are not limited to, a processing unit 1020 (such as a central processing unit, CPU), a system memory 1030, and a system bus 1021 that couples various system components including the system memory to the processing unit 1020. The system bus 1021 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 1010 typically includes a variety of computer readable media. Computer readable media can be any available media that can be accessed by the computer 1010 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 1010. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1040 includes computer storage media in the form of volatile and/or nonvolatile memory such as read only memory (ROM) 1031 and random access memory (RAM) 1032. A basic input/output system 1033 (BIOS), containing the basic routines that help to transfer information between elements within the computer 1010, such as during start-up, is typically stored in ROM 1031. RAM 1032 typically contains data and/or program modules that are immediately accessible to and/or presently being operated on by processing unit 1020. By way of example, and not limitation, FIG. 10 illustrates operating system 1034, application programs 1035, other program modules 1036, and program data 1037.

The computer 1010 may also include other removable/non-removable, volatile/nonvolatile computer storage media. By way of example only, FIG. 10 illustrates a hard disk drive 1041 that reads from or writes to non-removable, nonvolatile magnetic media, a magnetic disk drive 1051 that reads from or writes to a removable, nonvolatile magnetic disk 1052, and an optical disk drive 1055 that reads from or writes to a removable, nonvolatile optical disk 1056 such as a CD ROM or other optical media.

Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1041 is typically connected to the system bus 1021 through a non-removable memory interface such as interface 1040, and magnetic disk drive 1051 and optical disk drive 1055 are typically connected to the system bus 1021 by a removable memory interface, such as interface 1050.

The drives and their associated computer storage media discussed above and illustrated in FIG. 10, provide storage of computer readable instructions, data structures, program modules and other data for the computer 1010. In FIG. 10, for example, hard disk drive 1041 is illustrated as storing operating system 1044, application programs 1045, other program modules 1046, and program data 1047. Note that these components can either be the same as or different from operating system 1034, application programs 1035, other program modules 1036, and program data 1037. Operating system 1044, application programs 1045, other program modules 1046, and program data 1047 are given different numbers here to illustrate that, at a minimum, they are different copies. A user may enter commands and information (or data) into the computer 1010 through input devices such as a keyboard 1062, pointing device 1061, commonly referred to as a mouse, trackball or touch pad, and a touch panel or touch screen (not shown).

Other input devices (not shown) may include a microphone, joystick, game pad, satellite dish, scanner, radio receiver, or a television or broadcast video receiver, or the like. These and other input devices are often connected to the processing unit 1020 through a user input interface 1060 that is coupled to the system bus 1021, but may be connected by other interface and bus structures, such as, for example, a parallel port, game port or a universal serial bus (USB). A monitor 1091 or other type of display device is also connected to the system bus 1021 via an interface, such as a video interface 1090. In addition to the monitor, computers may also include other peripheral output devices such as speakers 1097 and printer 1096, which may be connected through an output peripheral interface 1095.

The computer 1010 may operate in a networked environment using logical connections to one or more remote computers, such as a remote computer 1080. The remote computer 1080 may be a personal computer, a server, a router, a network PC, a peer device or other common network node, and typically includes many or all of the elements described above relative to the computer 1010, although only a memory storage device 1081 has been illustrated in FIG. 10. The logical connections depicted in FIG. 10 include a local area network (LAN) 1071 and a wide area network (WAN) 1073, but may also include other networks. Such networking environments are commonplace in offices, enterprise-wide computer networks, intranets and the Internet.

When used in a LAN networking environment, the computer 1010 is connected to the LAN 1071 through a network interface or adapter 1070. When used in a WAN networking environment, the computer 1010 typically includes a modem 1072 or other means for establishing communications over the WAN 1073, such as the Internet. The modem 1072, which may be internal or external, may be connected to the system bus 1021 via the user input interface 1060, or other appropriate mechanism. In a networked environment, program modules depicted relative to the computer 1010, or portions thereof, may be stored in the remote memory storage device. By way of example, and not limitation, FIG. 10 illustrates remote application programs 1085 as residing on memory device 1081. It will be appreciated that the network connections shown are exemplary and other means of establishing a communications link between the computers may be used.

The foregoing Detailed Description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A computer-implemented method for processing a streaming language query of a data stream log stored in a file system, comprising:
translating the streaming language query into a database management system query; and
evaluating the database management system query against the data stream log to obtain query results.

2. The computer-implemented method of claim 1, further comprising:
archiving the data stream to obtain an archived data stream log; and
determining whether the archived data stream log is in a canonical history table format;
if the archived data stream log is in a canonical history table format, then outputting a cleaned-up data stream log in canonical history table format; and
if the archived data stream log is not in a canonical history table format, then determining that the archived data stream log is a log of an archived bitemporal data stream log;
wherein the data stream log is the cleaned-up data stream log.

3. The computer-implemented method of claim 2, further comprising:
determining retraction events in the archived bitemporal data stream log;
incorporating the retraction events into content changes of a virtual relation;
generating a canonical history table of the archived bitemporal data stream log using the content changes of the virtual relation to store the eventual content of the virtual relation such that tuple ordering is immaterial to generate the cleaned-up data stream log in canonical history table format; and
outputting the cleaned-up data stream log in canonical history table format.

4. The computer-implemented method of claim 1, further comprising:
defining the streaming language query as a composition of streaming operators;
categorizing each of the streaming operators in the composition as one of: (1) SQL-like operator; (b) snapshot-oriented operator; (c) group&Apply operator;
translating each of the streaming operators in the composition separately using a translation technique that is selected based on the categorization to obtain translation results for each of the streaming operators; and
composing the translation results for each of the streaming operators to generate the database management system query.

5. The computer-implemented method of claim 4, further comprising:
categorizing the streaming operator as a SQL-like operator; and
determining a type of SQL-like operator of the streaming operator.

6. The computer-implemented method of claim 5, further comprising:
determining that the streaming operator is a stateless operator and determining a type of stateless operator;
if the stateless operator is a SELECTION operator, then using a SELECTION translation technique to obtain the database management system query;
if the stateless operator is a PROJECT operator, then using a PROJECT operator translation technique to obtain the database management system query;
if the stateless operator is an ALTERLIFETIME operator, then using an ALTERLIFETIME operator translation technique to obtain the database management system query; and
if the stateless operator is a UNION operator, then using a UNION operator translation technique to obtain the database management system query.

7. The computer-implemented method of claim 5, further comprising:
determining that the streaming operator is a JOIN operator; and
using a JOIN translation technique to obtain the database management system query.

8. The computer-implemented method of claim 4, further comprising:
categorizing the streaming operator as a snapshot-oriented operator;
defining C as an array of end points of valid intervals of tuples in the data stream; and
generating the C array using a CREATEVIEW statement in a structured query language.

9. The computer-implemented method of claim 8, further comprising:
defining a relation, D, as a relation containing piecewise segments of points in the C array;
generating the relation, D, using a CREATEVIEW statement in a structured query language;
determining whether multi-dimensional indexing is available;
if multi-dimensional indexing is available, then iterating over D to correlate D and the data stream;
if multi-dimensional indexing is not available, then iterating over the data stream to correlate D and the data stream; and
use the correlation between D and the data stream to obtain a translated snapshot-oriented operator as a database management system query.

10. The computer-implemented method of claim 8, further comprising:
defining a relation, D, in terms of a RANK function in a structured query language;
generating the relation, D, using a CREATEVIEW statement in a structured query language;
determining whether multi-dimensional indexing is available;
if multi-dimensional indexing is available, then iterating over D to correlate D and the data stream;
if multi-dimensional indexing is not available, then iterating over the data stream to correlate D and the data stream; and
use the correlation between D and the data stream to obtain a translated snapshot-oriented operator as a database management system query.

11. The computer-implemented method of claim 4, further comprising:
categorizing the streaming language query as a GROUP&APPLY operator;
defining a GROUPBY attribute X;
defining an APPLY expression, which is a complex event detection and response (CEDR) expression, to apply to each substream of the data stream, S, defined by tuples in S with the same X value;
translating the GROUP&APPLY operator in the APPLY expression to a table-valued function using a value of the GROUPBY attribute X as an input parameter;
using a SELECT DISTINCT statement to obtain a set V, where V is a set of distinctly X values in S;
for each value v in V, evaluating the table-valued function corresponding to a top-level operator of the APPLY expression by using a CROSS APPLY operator to generate a translated GROUP&APPLY operator as a database management system query.

12. A method for translating a streaming language query into a structured query language (SQL) query, comprising:
input the streaming language query;
defining the streaming language query as a composition of streaming operators;
categorizing each of the streaming operators in the composition;
translating each of the streaming operators in the composition separately using a translation technique selected based on the categorization;
if the streaming operator is categorized as a SQL-like operator, then translating the streaming operator using a SQL-like operator translation technique;
if the streaming operator is categorized as a snapshot-oriented operator, then translating the streaming operator using a snapshot-oriented operator translation technique;
if the streaming operator is categorized as a GROUP&APPLY operator, then translating the streaming operator using a GROUP&APPLY operator translation technique;
composing translation results of the translation of each of the streaming operators to generate a SQL query; and
output the SQL query that is a translation of the streaming language query.

13. The method of claim 12, further comprising:
defining the streaming language query as a complex event detection and response (CEDR) query, Q;
defining Q as Q=ν(Q₁)⁵, where, ν is a unary CEDR operator, and Q₁ is a first CEDR query; and
defining a translation function, T[.], as T[Q]=(T[ν])(T[Q₁]). and
using the translation function to translate the streaming language query into a SQL query.

14. The method of claim 12, further comprising:
defining the streaming language query as a complex event detection and response (CEDR) query, Q;
defining Q as Q=ν(Q₁, Q₂), where, ν is a binary CEDR operator, and Q₁ is a first CEDR query and Q₂ is a second CEDR query;
defining a translation function, T[.], as T[Q]=(T[ν])(T[Q_{1],T[Q}₂]). and
using the translation function to translate the streaming language query into a SQL query.

15. The method of claim 12, further comprising:
defining one of the streaming operators as a snapshot-oriented operator;
defining a C array as an array of end points of valid intervals of tuples in a data stream, S, the valid interval having a valid start time, Vₛ, and a valid end time, Vₑ;
generating the C array using the following SQL statement:
CREATE VIEW V_{C} AS
SELECT DISTINCT V_{S} AS Point
FROM S
UNION
SELECT DISTINCT Vₑ AS Point
FROM S;
defining a relation, D, as a relation containing piecewise segments of points in the C array;
generating the relation, D, using the following SQL statement:
CREATE VIEW RankedC AS
SELECT Point, rank( ) OVER (ORDER BY Point) AS Rank
FROM V_{C}
CREATE VIEW D AS
SELECT C1.Point AS start, C2.Point AS end
FROM RankedC AS C1, RankedC AS C2
WHERE C2.Rank = C1.Rank+1;
correlating D and S to obtain a translated snapshot-oriented operator as a portion of a SQL query.

16. The method of claim 15, further comprising:
determining that multi-dimensional indexing is available; and
iterating over D for a given tuple in D using a CROSS APPLY operator to aggregate over relevant tuples in S using the following SQL statement:
```
CREATE VIEW AggResult AS
SELECT D.V_{S} AS V_{S}, D.Vₑ AS Vₑ, AggValue
FROM D
CROSS APPLY (
  SELECT AGGTYPE(X) AS AggValue
  FROM S
  WHERE S. V_{S} <= D.V_{S} AND S.Vₑ >= D.Vₑ
) AS ApplyResult.
```

17. The method of claim 15, further comprising:
determining that multi-dimensional indexing is not available; and
iterating over S by joining D with S to obtain shredded tuples using the following SQL statement:
CREATE VIEW ShreddedInput AS
SELECT D.V_{S} AS V_{S}, D.Vₑ AS Vₑ, P
FROM S, D
WHERE S.V_{S} <= D.V_{S} AND S.Vₑ > D.V_{S}; and
aggregating the shredded tuples according to their valid interval values using the following SQL statement:
CREATE VIEW AggResult AS
SELECT V_{S}, Vₑ, AGGTYPE(X)
FROM ShreddedInput
GROUP BY V_{S}, Vₑ.

18. A process for applying a structured query language (SQL) query to a data stream log, comprising:
generating a streaming language query for the data stream log;
defining the streaming language query as a composition of streaming operators;
categorizing each of the streaming operators as one of: (a) a SQL-like operator; (b) a snapshot-oriented operator; (c) a GROUP&APPLY operator;
translating each of the streaming operators in the composition separately into a corresponding SQL operator using a translation technique selected based on the categorization of the streaming operator;
composing translation results obtained from the translation of each of the streaming operators to generate the SQL query; and
applying the translated streaming language query as the SQL query to the data stream log to obtain a query results log.

19. The process as set forth in claim 18, further comprising:
categorizing one of the streaming operators as a complex event detection and response (CEDR) join operator; and
translating the CEDR join operator into a corresponding SQL operator using the following SQL statement: SELECT max(S1. Vₛ, S2. Vₛ) AS Vₛ, min(S1. Vₑ, S2.Vₑ) AS Vₑ, P FROM S1, S2, WHERE θ^{SQL} AND S1.Vₛ<S2.Vₑ AND S2.Vₛ<S1Vₑ;
wherein P is payload attributes of input streams S₁ and S_{2, and θ}^{SQL} is a join predicate θ in SQL syntax.

20. The process as set forth in claim 18, further comprising:
categorizing one of the streaming operators as a AlterLifeTime operator; and
translating the AlterLifeTime operator into a corresponding SQL operator using the following SQL statement: CREATE VIEW V_{0 AS SELECT V}ₛ, Vₛ+2 AS Vₑ, tid FROM S;
wherein S is an input stream, tid is a thread identification, V is a valid interval of tuples in the input stream, S, wherein the valid interval has a valid start time, Vₛ, and a valid end time, Vₑ.
